(19) United States
(12) Patent Application Publication
(10) Pub. No.: US 2026/0212775 A1
(43) Pub. Date: Jul. 23, 2026

(54) ARTIFICIAL INTELLIGENCE-DRIVEN DYNAMIC INTEGRATION OF INDIVIDUAL IMMERSIVE EDUCATION SYSTEM WITH IMPROVED LEARNING EFFECTIVENESS

(71) Applicant: International Business Machines Corporation, Armonk, NY (US)

(72) Inventors: Natalie BROOKS POWELL, Bolingbrook, IL (US); Sarbajit Kumar RAKSHIT, Kolkata (IN); Selvi JOHN, Bangalore (IN); Santosh RAJASHEKAR, Bangalore (IN)

(21) Appl. No.: 19/027,413

(22) Filed: Jan. 17, 2025

(51) Int. Cl. G09B 5/06; G06N 3/0464; G06N 3/0475

(52) U.S. Cl. CPC G09B 5/065; G06N 3/0464; G06N 3/0475

(57) ABSTRACT

Method and apparatus are provided for dynamic integration of individual educational sessions with varying modes of delivery to improve learning effectiveness. The method including accessing a data repository comprising a plurality of educational sessions, generating mode tags for each session to specify a mode of education delivery, generating content tags for each session to specify a topic of instruction, creating one or more profiles to track participant actions, where each profile comprises one or more effectiveness metrics across a combination of sessions attended by a participant, training a ML model to learn correlations between the combinations of sessions and the effectiveness metrics, predicting one or more effectiveness metrics for other combinations of sessions lacking profile data, clustering the combinations of sessions indicated in the profiles and the other combinations of sessions using the effectiveness metrics, and selecting one or more candidate combinations of sessions for aggregation based on the clustering.

### BACKGROUND

The present disclosure relates to immersive educational session integration, and more specifically, to dynamically integrating individual immersive educational sessions with different modes of delivery into an aggregated program with improved learning effectiveness.

### SUMMARY

One embodiment presented in this disclosure provides a method, including accessing a data repository comprising a plurality of educational sessions, generating one or more mode tags for each session to specify a mode of education delivery, generating one or more content tags for each session to specify a topic of instruction, creating one or more profiles to track participant actions, where each profile comprises one or more effectiveness metrics across a combination of sessions attended by a participant, training a machine learning (ML) model to learn correlations between the combinations of sessions and the effectiveness metrics, as indicated in the one or more profiles, predicting one or more effectiveness metrics for other combinations of sessions lacking profile data using the trained ML model, clustering the combinations of sessions indicated in the profiles and the other combinations of sessions using the effectiveness metrics, and selecting one or more candidate combinations of sessions for aggregation based on the clustering.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, wherein the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts a collection of example immersive educational sessions, according to some embodiments of the present disclosure.

FIG. 3 depicts a collection of example participant profiles, according to some embodiments of the present disclosure.

FIG. 4 depicts an example workflow for artificial intelligence (AI)-driven session analysis and aggregation, according to some embodiments of the present disclosure.

FIGS. 5A and 5B depict an example method for dynamic integration of individual sessions into an aggregated session for improved learning effectiveness, according to some embodiments of the present disclosure.

FIG. 6 is a flow diagram depicting an example method for AI-driven session analysis and aggregation, according to some embodiments of the present disclosure.

### DETAILED DESCRIPTION

In the evolving landscape of immersive virtual education, courses offer diverse learning modes, such as the theory class, demonstration class, real-life scenarios, and use case studies, each providing unique learning experiences to participants. While these specialized course sessions cater to varied learning preferences, individual sessions often lack the cohesiveness necessary for a well-rounded education. Limited interaction, potential disengagement, and challenges in applying knowledge to real-world contexts are prevalent issues for participants when attending these session separately without cohesive integration. The challenge lies in optimizing these individual sessions across different modes to provide a comprehensive and engaging educational experience. Furthermore, a lack of collaboration and integration among diverse virtual sessions hinders the maximization of learning effectiveness, often leaving students with fragmented or incomplete understanding of complex topics.

The present disclosure introduces methods, systems, and apparatus that dynamically integrate individual learning sessions into an aggregated program. This aggregated program provides an immersive and cohesive educational experience, delivering well-rounded education for complex topics in contrast to fragmented learning through individual sessions. Each session in the data repository of the immersive education system (or platform) can be processed with content and mode tags, which allows artificial intelligence (AI)-driven analysis to evaluate effectiveness of different learning approaches. Through the application of generative models and clustering algorithms, the disclosed system identifies high-performance combinations of sessions across diverse learning modes. These sessions are then combined into an aggregated program and deployed to a collaborative environment (or platform), where multiple participants can engage and interact together. The disclosed system enhances learning by generating an aggregated program that integrates individual sessions with diverse learning modes. The aggregated program ultimately delivers a structured and highly effective learning experience to participants within the virtual environment, supporting cohesive understanding of complex topics and improving learning effectiveness.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

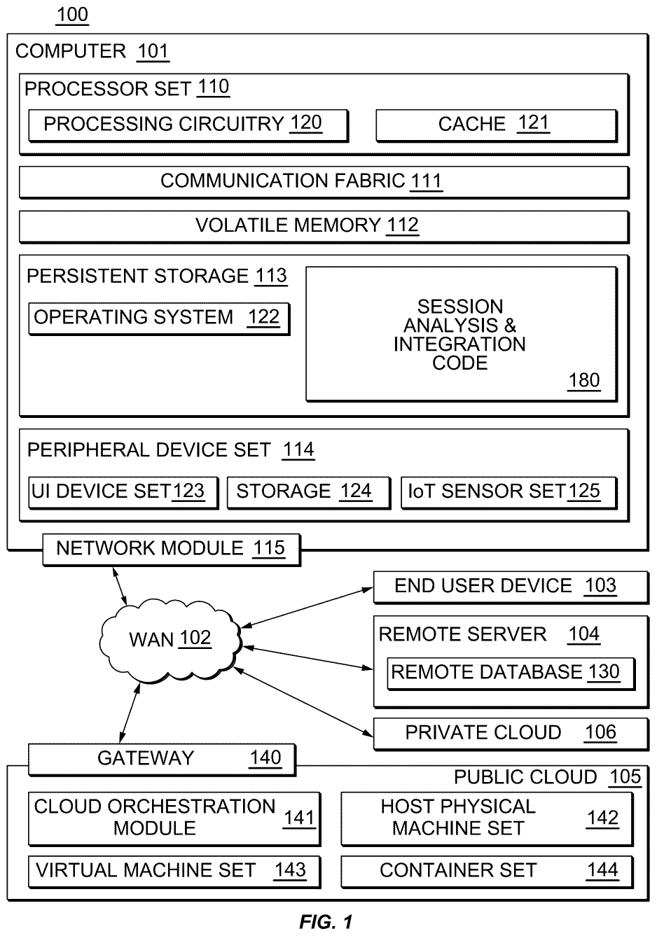

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Session Analysis & Integration Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Session Analysis & Integration Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch, or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Session Analysis & Integration Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Session Analysis & Integration Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

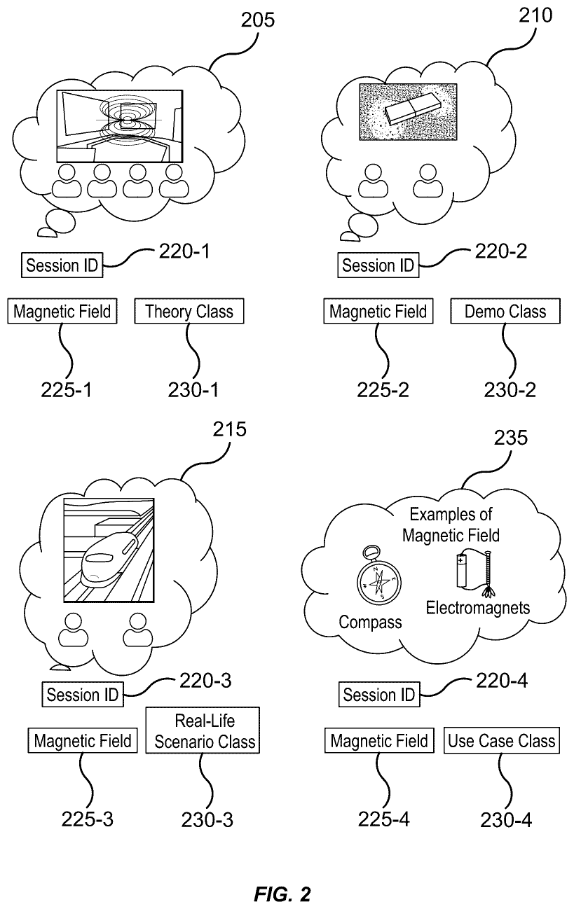

FIG. 2 depicts a collection of example immersive educational sessions, according to some embodiments of the present disclosure.

The immersive education system is a platform designed to deliver a dynamic, immersive, and multi-mode learning experience within a virtual environment. The system supports diverse instructional formats and enables students to engage with content in a way that combines theoretical knowledge with practical applications. The system is connected to a data repository, which may be configured as either cloud-based storage or local storage (or a combination thereof). The data repository contains a large amount of educational sessions or courses on various topics. Sessions in the data repository may be live-streamed for real-time participation and/or pre-recorded for on-demand access. The repository may support a range of learning modes (also referred to in some embodiments as modes of education delivery), allowing the system to generate customized learning programs based on specific learning objectives.

In addition to the data repository, the immersive education system may include various hardware and software components to support the learning experience. In some embodiments, hardware components may include virtual or augmented reality devices, cameras, and sensors that improve interactivity and engagement. In some embodiments, software components may include the use of supervised machine learning algorithms, generative models, and clustering algorithms to perform session analysis and selection, dynamic session combination and sequencing, and cross-collaborative interaction. These components together allow the immersive education system to provide a well-rounded, effective, and adaptable educational experience across diverse learning sessions.

For each learning topic, there may be a variety of sessions prepared by any number of instructors and/or education institutions. These sessions may be categorized into various types, such as theory classes, demonstration classes (as referred hereafter as demo classes), real-life scenario classes, and use case classes. Each type of class serves a distinct purpose. Theory classes provide a traditional lecture-based format in which instructors present foundational concepts in a structured manner to students. The theory classes offer students with clear explanations and a strong theoretical base. However, this format of class often has limited interactivity and offers limited benefits for students who prefer hands-on learning experience. Demo classes allow instructors to demonstrate practical applications or procedures related to theoretical concepts, giving the students the chance to visually observe the concepts in action. This format increases engagement by providing tangible examples, but it may have limited interactivity and may not capture the full complexity of real-world scenarios. Real-life scenario classes take theoretical knowledge a step further by applying it to real-world situations, often through case studies or simulations. These sessions build problem-solving skills and contextual understanding, offering students a direct link between theory and practice. However, without a foundational understanding of the underlying theory, students may find real-life scenario classes challenging. Use case classes explore different applications or examples of a specific concept. These sessions provide a comprehensive understanding and encourage critical thinking. As with real-life scenario classes, a solid theoretical foundation is required for students to fully benefit from use case classes.

The immersive education system disclosed in the present disclosure hosts a vast repository of individual sessions across various topics and learning modes. However, the system in the present disclosure further processes each session to generate specific content and mode tags. This tagging enables the system to perform detailed session analysis and selection in subsequent operations, and ultimately generate an aggregated program adapted to maximize (or at least improve) learning effectiveness for participants.

FIG. 2 depicts three example individual sessions 205, 210, and 215 within the disclosed immersive education system. As shown, each session is assigned a unique session identifier (ID) 220 and categorized with specific tags 225 and 230 that identify the session's topic and mode of education delivery, respectively. The disclosed immersive education system may use these tags to organize and retrieve sessions based on their content and instructional approach.

As depicted, session 205 is a theory class on the topic of magnetic fields. The session 205 has a unique session ID 220-1 and includes two tags: a content tag 225-1 labeled “Magnetic Field,” which identifies the topic, and a mode tag 230-1 labeled “Theory Class,” which indicates that the session is a lecture-based session focused on presenting theoretical concepts.

Session 210 is a demo class for the same topic of magnetic fields. This session also has its own session ID 220-2, along with a content tag 225-2 of “Magnetic Field” and a mode tag 230-2 of “Demo Class.” The content tag indicates the subject matter of the session, and the mode tag specifies that the session is an instructional demonstration designed to visually illustrate the practical applications of magnetic fields.

Session 215 is a real-life scenario class that demonstrates the application of magnetic fields in real-world situations. Like the other two sessions, session 215 has a unique session ID 220-3 and includes a content tag 225-3 of “Magnetic Field” and a mode tag 230-3 of “Real-Life Scenario Class.”

The session 235 is a use case class that explores various applications of magnetic fields across different scenarios. Similar to the other three sessions, session 235 has its own unique session ID 220-4, along with a content tag 225-4 “Magnetic Field” 225-4 and a mode tag 230-4 of “Use Case Class.”

In some embodiments, the content tag 225 for each session may be identified using natural language processing (NLP) algorithms. NLP algorithms may be applied to analyze the textual content or transcripts associated with a session to extract relevant keywords and phrases. Based on the extracted keywords or phrases, the system may identify topics (e.g., magnetic fields) discussed in this session.

In some embodiments, the mode tag 230 (also referred to in some embodiments as the tag for a mode of education delivery) may be identified through a combination of NLP and convolutional neural networks (CNNs). NLP techniques may be used to examine the session's textual data, detecting features that indicate a specific instructional approach, such as theoretical explanation, procedural steps, or context-based problem-solving. For sessions containing visual content, CNNs may be applied to analyze video or image data to extract features that represent specific instructional elements, like demonstrations, practical applications, or real-live examples. Once these features are extracted, trained machine learning (ML) models may classify the session into one of the learning modes based on the analyzed data. For example, the system may use ML to determine whether the session falls under the theory class, demo class, real-life scenarios, use case class, and the like.

The four example sessions in FIG. 2 are provided for conceptual clarity. In some embodiments, the data repository within the immersive education system may contain other individual sessions on the topic of magnetic fields. For each class type under this topic, there may be multiple sessions prepared by various instructors or institutions. For example, the repository may include twenty theory classes, thirty demo classes, ten real-life scenario classes, and seven use case classes, all on the topic of magnetic fields and developed by different educational sources. A participant interested in learning about magnetic fields may randomly select and attend these courses individually.

In some embodiments, to provide a more structured approach, the disclosed immersive education system may incorporate a tracking module that monitors each participant's actions during these sessions. This tracking module may record actions such as asking questions, participating in discussions, interacting with virtual objects, any body language or gestures that indicated focused attention, and more. By analyzing these actions, the system may assess the effectiveness of each session for the individual and calculate session-specific effectiveness metrics. These metrics, along with the tracked actions, may be stored within the participant's profile. When a participant takes a sequence of classes on the same topic, such as several theory, demo, and real-life scenario classes on magnetic fields, the disclosed system may calculate program-level effectiveness metrics for that specific topic and store the data in the participant's profile.

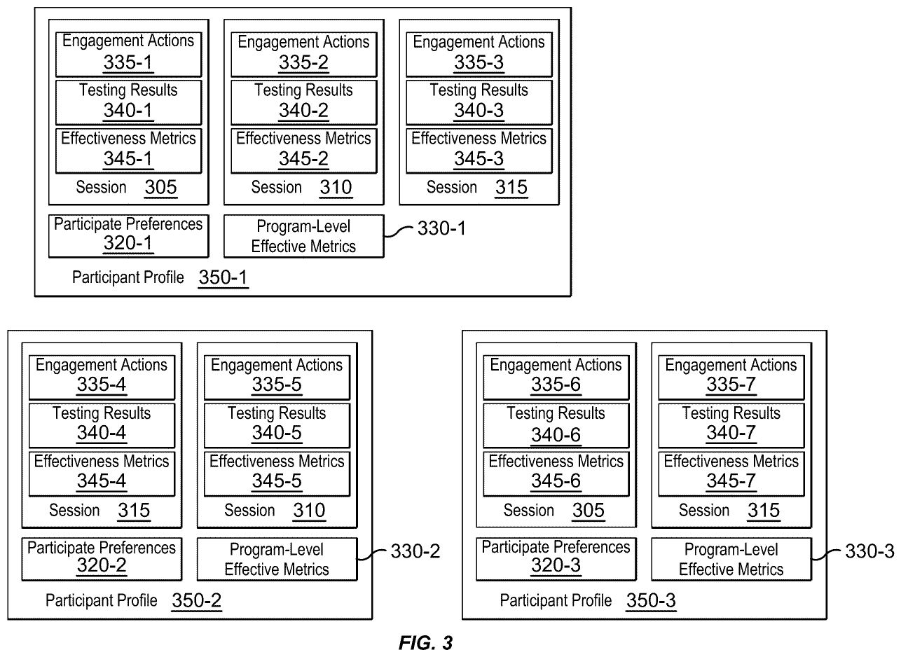

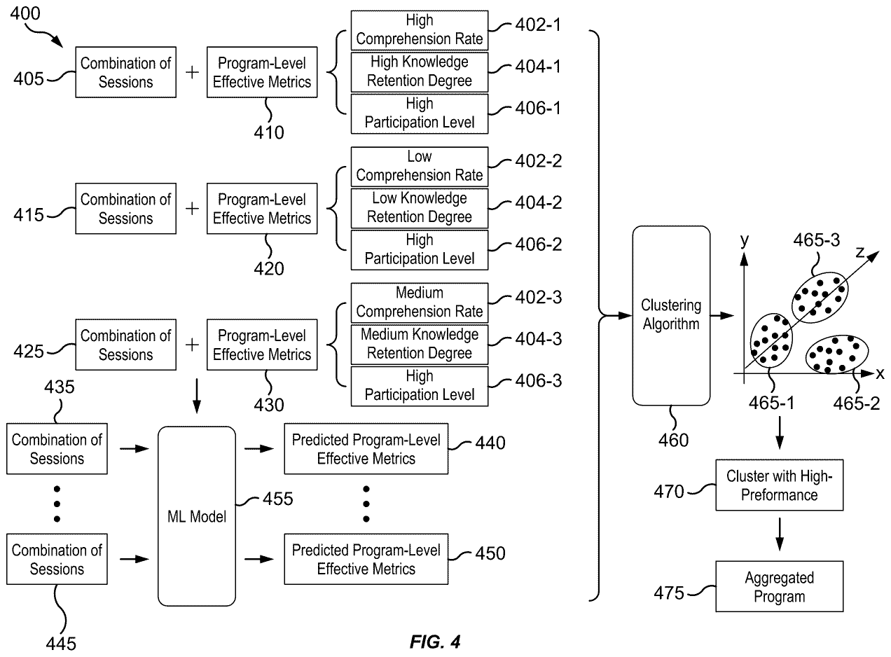

The extensive data stored in each participant's profile provides an overview of how various combinations of sessions impact learning effectiveness across different topics and learning modes. By using this data as a training dataset, the ML model may learn patterns and correlations between specific session combinations and their associated effectiveness metrics. More details about the data saved in each profile are discussed below with reference to FIG. 3. More details about the model training process are discussed below with reference to FIG. 4.

FIG. 3 depicts a collection of example participant profiles, according to some embodiments of the present disclosure.

Each participant profile 350 in the disclosed immersive education system includes personalized information about the participant's preferences 320, such as preferred learning modes, topics of interest, and engagement styles. Additionally, the profile 350 contains a record of the individual sessions that the participant has attended. For each attended session, the profile records detailed actions 335 taken by the participant, such as asking questions, participating in discussions, interacting with virtual objects, and any gestures or body language indicating focused attention and engagement. The profile also includes results 340 from various testing methods, such as quizzes, interactive assessments, end-of-session evaluations, and periodic knowledge checks. These testing results 340 and tracked actions 335 are collectively used to calculate session-specific learning effectiveness metrics. These metrics may include, but are not limited to, the comprehension rate, knowledge retention degree, and participant level. As used herein, the comprehension rate refers to the extent to which a participant accurately understands the content presented in a session. In some embodiments, the comprehension rate may be determined based on responses to quiz questions and/or end-of-session evaluations. As used herein, the knowledge retention degree refers to a participant's ability to retain and recall learned information over time. In some embodiments, the knowledge retention degree may be determined through follow-up quizzes, post-session reviews, and periodic knowledge checks. As used herein, participation level refers to the degree of active involvement by the participant, based on actions such as interaction frequency, contribution to discussion, and engagement with interactive elements.

When a participant attends a series of individual sessions across various learning modes for the same topic (e.g., identified by their content tags), the system may calculate program-level (or topic-specific) effectiveness metrics 330. The program-level metrics 330 reflect the participant's overall comprehension, engagement, and retention across all attended sessions for the specific topic (e.g., magnetic fields).

As depicted, three participant profiles 350-1, 350-2, and 350-3 are provided. The participant profile 350-1 shows that a participant attended three individual sessions on the topic of magnetic fields. More specifically, the participant attended session 305 (a theory class on magnetic fields) (which may correspond to 205 as depicted in FIG. 2) first, followed by session 310 (a demo class on magnetic fields) (which may correspond to 210 as depicted in FIG. 2), and finally session 315 (a real-life scenario class on magnetic fields) (which may correspond to 215 as depicted in FIG. 2). Within each session, the participant's actions (e.g., asking questions, participating in discussion, and interacting with virtual objects) 335-1, 335-2, and 335-3, as well as results from various assessments and quizzes 340-1, 340-2, and 340-3, are tracked and recorded. Based on the recorded actions 335 and testing results 340, session-specific effectiveness metrics (e.g., comprehension rate, knowledge retention degree, and participation level) 345-1, 345-2, and 345-3 are calculated and recorded for each session. Additionally, the program-level effectiveness metrics 330-1 are calculated and recorded. The program-level effectiveness metrics represent the cumulative learning outcomes achieved by a participant across a sequence of sessions attended for a specific topic. In profile 350-1, the program-level effectiveness metrics 330-1 represent the combined effectiveness of attending session 305 (theory class), session 310 (demo class), and session 315 (real-life scenario class) in the depicted order.

Profile 350-2 represents a different sequence, where a participant attended session 315 (real-life scenario class) first, followed by session 310 (demo class). Within each session, the participant's actions 335-4 and 335-5 and testing results 340-4 and 340-5 are tracked and recorded. The corresponding session-specific effectiveness metrics 345-4 and 345-5 are calculated based on the observed actions and testing results. Additionally, the overall program-level effectiveness metrics 330-2 are generated for this distinct sequence of sessions.

The participant for profile 350-3 attends session 305 (theory class) first, followed by session 315 (real-life scenario class). This profile similarly includes recorded actions 335-5 and 335-7 and testing results 340-6 and 340-7 for each action, with corresponding session-specific effectiveness metrics 345-6 and 345-7. Relevant program-level effectiveness metrics 330-3 are also calculated for this specific sequence.

In some embodiments, the program-level effectiveness metrics 330 may be quantified as specific continuous values, such as a comprehension rate of 85%, a knowledge retention degree of 75%, or a participation level score of 85. In some embodiments, the program-level effectiveness metrics 330 may be represented as categorical ratings, such as high, medium, or low comprehension rate, knowledge retention degree, or participation level.

The depicted profiles 350-1, 350-2, and 350-3 are provided for conceptual clarity, illustrating how the system tracks individual session sequences and calculates effectiveness metrics. In some embodiments, each participant may attend a wide variety of sessions across various topics within the immersive education system. For a specific topic, such as magnetic fields, the sequence of attended sessions may be identified using content tags (e.g., 225 of FIG. 2) associated with each session. In some embodiments, the system may use the timestamps recorded for each session to determine the order in which these topic-specific sessions are attended.

FIG. 4 depicts an example workflow for AI-driven session analysis and aggregation, according to some embodiments of the present disclosure.

As depicted, three combinations of sessions 405, 415, and 425, along with their corresponding program-level effectiveness metrics 410, 420, and 430, are used as training data for the machine learning model 455. The training process allows the model 455 to learn patterns and correlations between specific session sequences and/or session characteristics, and the resulting learning outcomes. These session characteristics may include a variety of factors such as the content sources (e.g., where certain instructors or organizations may provide higher-quality or at least differently structured or presented material), the delivery style of each session, the preferences of the user ingesting the content, and the like. Once trained, the model 455 is configured to predict effectiveness for new combinations of sessions.

The combination of session 405 may correspond to the session sequence as indicated in profile 350-1 as depicted in FIG. 3, which shows a participant attending session 305 (theory class) first, followed by session 310 (demo class), and then session 315 (real-life scenario class). For this sequence, the program-level effectiveness metrics 410 indicate a high comprehension rate 402-1, a high knowledge retention rate 404-1, and a high participation level 406-1. The combination of sessions 415 may correspond to the session sequence as indicated in profile 350-2 as depicted in FIG. 3, which shows a participant attending session 315 (real-life scenario class) first, followed by session 310 (demo class). This combination 415 results in a low comprehension rate 402-2, a low knowledge retention rate 404-2, and a high participation level 406-2. The combination of sessions 415 may correspond to the session sequence as indicated in profile 350-3 as depicted in FIG. 3, which shows a participant attending session 305 (theory class) first, followed by session 315 (real-life scenario class). This combination 425 leads to a medium comprehension rate 402-2, a medium knowledge retention rate 404-2, and a high participation level 406-2.

The three combinations of sessions, 405, 415, and 425, are provided as examples for conceptual clarity. In some embodiments, there may be a large number of combinations extracted from existing participant profiles (e.g., 350 of FIG. 3) and used as training data for the ML model 455. These combinations allows the model 455 to learn from a variety of sequences and instructional modes to improve its predictive accuracy. In some embodiments, the participants may not be limited to attending only one class of a specific learning mode for a given topic. For example, a participant may attend multiple theory classes on the same topic, each with unique session IDs, prepared by different instructors or institutions. This variation may add complexity to the potential combinations, as profiles may show participants attending more than one class of the same mode (e.g., two theory classes followed by a demo class) for a comprehensive understanding of the topic (e.g., magnetic fields).

The three combinations of sessions 405, 415, and 425, along with their corresponding effectiveness metrics 410, 420, and 430, serve as part of the training dataset for the ML model 455. In addition to these three examples, a large number of other combinations may be extracted from existing participant profiles (e.g., 350 of FIG. 3), each with unique sequence of sessions and associated effectiveness metrics. By training on these combinations, the ML model 455 learns to recognize how different session sequences impact overall learning effectiveness (e.g., comprehension, retention, engagement).

In some embodiments, the model 455 may use a random forest algorithm, which is robust in handling high-dimensional data and can automatically identify relevant features. During training, each decision tree within the random forest is trained on a random subset of the data. This approach introduces randomness that helps reduce the risk of overfitting and enhances the model's generalization to new data. Within each tree, the algorithm splits nodes based on the feature that more accurately predicts the effectiveness outcome, whether the output is categorical (classification) or continuous (regression).

Once trained, the ML model 455 may be applied to predict effectiveness metrics for new combinations of sessions 435 and 445 that lack existing profile data. As depicted, when provided with a new combination 435, the model 455 may estimate the likely comprehension rate, knowledge retention degree, and participation level based on patterns the model 455 learned during training. In embodiments where the effectiveness metrics 440 and 450 are continuous values, such as 85% for comprehension rate, 75% for knowledge retention degree, and a participation level score of 85, the model 455 may use regression trees to predict precise values. In embodiments where the output is discrete categories, such as high, medium, or low for comprehension rate, knowledge retention degree, and participation level, the model 455 may use classification trees to categorize the effectiveness metrics accordingly.

The combinations of sessions 405, 415, 425, 435, and 445, along with their corresponding effectiveness metrics 410, 420, 430, 440, and 450 (including those extracted from existing profiles and those predicted by the ML model 455), are provided as inputs to the clustering algorithm 460. The clustering algorithm 460 serves as part of an unsupervised ML model to organize the combinations based on their effectiveness metrics across three dimensions: comprehension rate, knowledge retention degree, and participation level. In the three-dimensional (3D) clustering space, each axis represents one of these metrics, allowing the algorithm 460 to group similar combinations into a cluster 465 according to their performance across these dimensions.

As depicted, the clustering algorithm 460 divides the combinations into different clusters 465, with each cluster containing combinations that share similar learning outcomes. Among these clusters 465, the cluster with high performance 470 (e.g., showing high values across three dimensions) is selected. Within the selected cluster 470, each combination may include a distinct sequence of individual sessions across different learning modes (also referred to as modes of education delivery). Using the combinations within the selected high-performance cluster 470, the system generates an aggregated program 475 for a specific topic (e.g., magnetic fields). The aggregated program 475 integrates the most effective session sequences from the cluster and offers a structured learning pathway that maximizes (or at least improves) learning effectiveness.

In some embodiments, when generating the aggregated program 475, besides considering the candidate combinations within the selected cluster 470, the system may further consider the compatibility of these sessions with the individual participant's profile and adjust internal sequence accordingly. This analysis may involve evaluating the participant's learning preferences (e.g., 320 of FIG. 3) as stored in the profile. For example, if a participant's profile indicates a preference for practical, hands-on learning, the system may adjust the sequence by positioning the demo class earlier in the sequence, making the participant engage with practical examples sooner to boost his or her comprehension and engagement. If the participant shows a strong foundation in theoretical knowledge, the system may arrange real-life scenario or use case sessions in front of extended theory sessions.

In some embodiments, the aggregated program 475 may be on boarded (or launched) to a collaborative environment where multiple participants can attend the program together, supporting both synchronous (real-time) or asynchronous (independent) participation. In a synchronous configuration, participants may engage with each other in real time, share insights, and discuss content directly. In an asynchronous configuration, participants may access the program at their own pace, leaving comments, questions, and insights for others to review and respond to later. In embodiments where the aggregated program include both live-streaming sessions and recorded sessions, the system may use generative models, such as generative adversarial networks (GANs), to dynamically adapt the digital representations of participants (e.g., avatars of participants) from recorded sessions in response to real-time interactions occurring in the live-streaming sessions. For example, if a live-streaming participant asks a question or initiates a discussion, the generative model may adapt the digital representation of the participant (e.g., the avatar of the participant) in the recorded session to display facial expressions, gestures, or body language that mirror the engagement or responsiveness, making it appear as though the participants in the recorded session are actively reacting to the live dialogue.

The three effectiveness metrics (including comprehension rate, knowledge retention degree, and participation level) depicted in FIG. 4 are provided as examples for conceptual clarity. In some embodiments, other metrics may be incorporated to evaluate the learning outcomes. For example, additional metrics like application proficiency (which measures the participant's ability to apply learned concepts to practical situations), engagement duration (which tracks the length of time a participant actively engages with the session content), and recall accuracy (which indicates how accurately a participant can remember specific information over time) may be tracked to assess a participant's capability to apply learned concepts in various contexts.

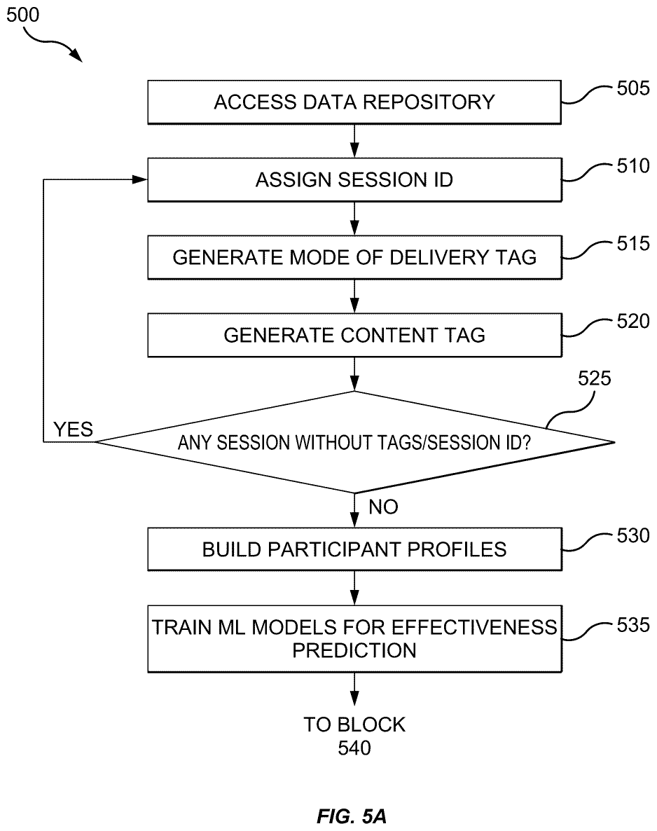

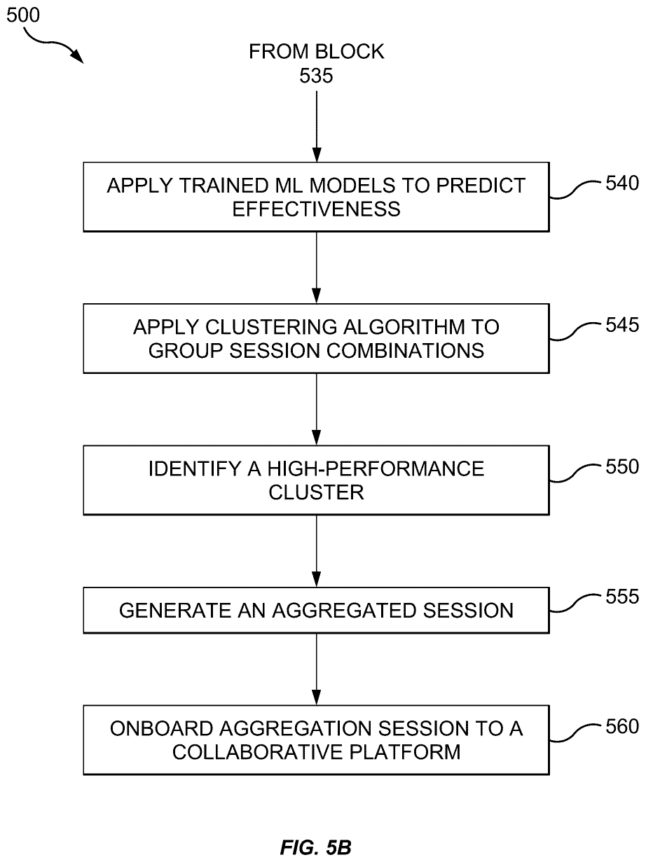

FIGS. 5A and 5B depict an example method 500 for dynamic integration of individual sessions into an aggregated session for improved learning effectiveness, according to some embodiments of the present disclosure. In some embodiments, the method 500 may be performed by one or more computing devices or systems, such as the computer 101 as depicted in FIG. 1. These computing devices or systems, comprising both hardware and software components, constitute a session analysis & integration system that is coupled with an immersive education platform (or system). The session analysis & integration system is configured to analyze, organize, and integrate individual sessions to create cohesive, high-effectiveness learning programs that improve participant engagement and optimize learning outcomes.

At block 505, a computing system accesses the data repository of an immersive education system. In some embodiments, the data repository may reside in local storage, cloud-based storage, or a combination of both. The data repository may include a large number of recorded and/or live-streaming sessions or courses across a variety of topics and instructional formats (e.g., theory classes, demo classes, real-life scenario classes, or use case classes). Participants may attend these sessions by using specific hardware devices, such as virtual reality (VR) headsets or augmented reality (AR) glasses, and engaging in classes in a fully immersive manner.

At block 510, the computing system assigns a unique identifier (ID) (e.g., 220 of FIG. 2) to each session (e.g., 205, 210, or 215 of FIG. 2) for precise identification and tracking. In some embodiments, session IDs may be used to monitor each participant's attendance and engagement with specific sessions and track the learning progress and session effectiveness across the immersive education platform.

At block 515, the computing system analyzes each session to generate a mode of delivery tag (e.g., 230 of FIG. 2), categorizing each session into one of four learning modes: theory class, demo class, real-life scenario class, or use case class. In some embodiments, the computing system may use NLP to analyze textual data, such as session descriptions, transcriptions, subtitles, and other related documents, and extract relevant features that indicate instructional style. For sessions containing visual content, CNNs may be used to analyze video or image data and identify features that suggest specific delivery modes. Once the relevant features are extracted, a trained classification model may be used to classify each session into its respective learning mode. Based on the classification, relevant tags may be generated.

At block 520, the computing system generates content tags (e.g., 225 of FIG. 2) for each sessions, identifying the specific educational topic involved (e.g., magnetic fields). In some embodiments, the system may use the content tags to generate a streamlined and organized topic list, through which participants may search courses for a specific topic. In some embodiments, NLP techniques may be used to analyze session descriptions, transcripts, or related content to extract keywords or phrases and identify the relevant topic.

At block 525, the computing system checks whether all sessions in the data repository have been assigned both a session ID and the relevant tags. If any session is found without these identifiers, the method 500 returns to block 510, where the computing system completes the assignment. If all sessions are properly tagged and identified, the method 500 proceeds to block 530.

At block 530, as participants attend individual sessions or courses, the system builds detailed profiles for each participant. The profile includes actions (e.g., 335 of FIG. 3) taken during these sessions (e.g., asking questions, participating in discussions, or interacting with virtual objects) and relevant effectiveness metrics for each individual (e.g., 345 of FIG. 3) (e.g., comprehension rate, knowledge retention degree, or participation level). When participants attend a sequence of sessions covering the same topic (e.g., multiple sessions on “Magnetic Field” across various learning modes), the system tracks program-level effectiveness metrics (e.g., 330 of FIG. 3) for the overall learning experience. These program-level metrics reflect the cumulative learning outcomes for this topic across the entire sequence.

At block 535, using the data collected from participant profiles (e.g., 350 of FIG. 3), the system trains a ML model (e.g., using random forest algorithms) (e.g., 455 of FIG. 4) to predict the effectiveness of different session combinations. The model is designed to recognize patterns and relationships between specific sequences of sessions, session characteristics (e.g., content sources, high-quality instructors, and the delivery styles), and resulting learning effectiveness. Once trained, the model can make predictions for new combinations of sessions that lack historical profile data, accounting for both session sequences and individual characteristics. In some embodiments, regression models may be used when predicting continuous effectiveness metrics, such as a specific comprehension rate (e.g., 85%), knowledge retention degree (e.g., 75%), or participation level score (e.g., 90). In some embodiments, classification models may be utilized when predicting categorical results, such as assigning comprehension rate, knowledge retention degree, or participation level into discrete categories (e.g., high, medium, or low categories).

At block 540 (in FIG. 5B), the system applies the trained ML model to predict effectiveness metrics (e.g., 440 or 450 of FIG. 4) for new combinations of sessions (e.g., 435 or 445 of FIG. 4) that do not have existing profile data. Using either the regression or classification models, the system may estimate effectiveness metrics (e.g., comprehension rate, knowledge retention degree, and participation level) for new session combinations.

At block 545, the system uses a clustering algorithm (e.g., 460 of FIG. 4) to group different session combinations based on their effectiveness metrics. This unsupervised ML algorithm organizes combinations across three dimensions (including comprehension rate, knowledge retention degree, and participation level) to create clusters of combinations (e.g., 465 of FIG. 4) with similar learning outcomes.

At block 550, from the clusters generated, the system identifies a high-performance cluster (e.g., 470 of FIG. 4) that contains session combinations associated with strong learning outcomes. The combinations within the selected cluster may serve as candidates for constructing an aggregated program (e.g., 475 of FIG. 4) with improved effectiveness, as these combinations represent sequences that have consistently demonstrated high comprehension rates, knowledge retention degrees, and participation levels.

At block 555, the system uses the candidate combinations within the high-performance cluster (e.g., 470 of FIG. 4) to generate an aggregated program (e.g., 475 of FIG. 4) (also referred to in some embodiments as an aggregated session). The aggregated program is structured by integrating a sequence of sessions that collectively provide an optimized learning path for a target topic. In some embodiments, the system may refine the aggregated program further by evaluating the compatibility of these sessions (included within the aggregated program) with the individual participant's preference. The system may consider the participant's learning preferences, strengths, weaknesses, and prior knowledge, and adjust the internal sequences of sessions based on these factors.

At block 560, the aggregated program (e.g., 475 of FIG. 4) is onboarded to a collaborative platform, where multiple participants may attend the program together (either simultaneously or independently). This platform allows for cross-collaboration, where participant may interact with each other and engage in discussion in real time. When the aggregated program includes a combination of both live-streaming and recorded sessions, generative models may be used to synchronize participant interactions. These models (e.g., GANs) may adapt the avatars or digital representations of participants in recorded sessions to respond to real-time interactions from those attending live sessions.

In some embodiments, the system may include a mechanism to continuously update the aggregated program based on ongoing effectiveness metrics and participant feedback. As participants engage with the program, the system may collect real-time data on metrics like comprehension rate, knowledge retention degree, and participation level. Additionally, the system may gather direct feedback from participants, which may include comments on the session's clarity, pacing, or engagement level. Using the data, the system may adjust the sequence, pacing, or content of sessions within the aggregated program, making it better align with participant needs and optimize overall learning effectiveness.

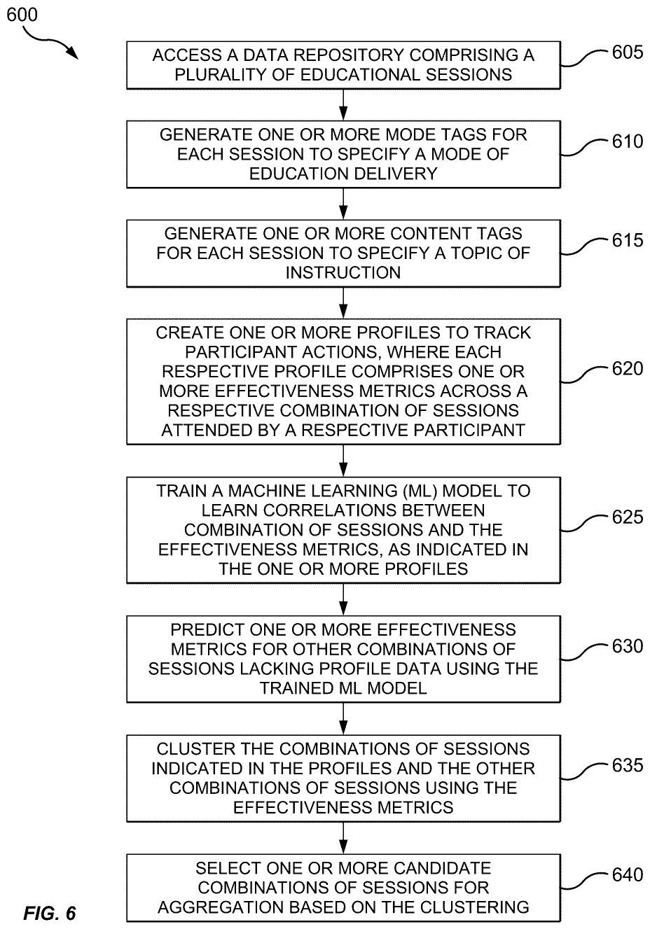

FIG. 6 is a flow diagram depicting an example method 600 for AI-driven session combination analysis and aggregation, according to some embodiments of the present disclosure.

At block 605, a computing device accesses a data repository comprising a plurality of educational sessions (e.g., 205, 210, or 215 of FIG. 2).

At block 610, the computing device generates one or more mode tags (e.g., 230 of FIG. 2) for each session to specify a mode of education delivery.

At block 615, the computing device generates one or more content tags (e.g., 225 of FIG. 2) for each session to specify a topic of instruction.

At block 620, the computing device creates one or more profiles (e.g., 350 of FIG. 3) to track participant actions, where each respective profile comprises one or more effectiveness metrics (e.g., 330 of FIG. 3) across a respective combination of sessions attended by a respective participant.

At block 625, the computing device trains a machine learning (ML) model (e.g., 455 of FIG. 4) to learn correlations between combination of sessions (e.g., 405, 415, or 425 of FIG. 4) and the effectiveness metrics (e.g., 410, 420, or 430 of FIG. 4), as indicated in the one or more profiles.

At block 630, the computing device predicts one or more effectiveness metrics (e.g., 440 or 450 of FIG. 4) for other combinations of sessions (e.g., 435 or 445 of FIG. 4) lacking profile data using the trained ML model.

At block 635, the computing device clusters the combinations of sessions indicated in the profiles and the other combinations of sessions using the effectiveness metrics.

At block 640, the computing device selects one or more candidate combinations of sessions (e.g., 465 of FIG. 4) for aggregation based on the clustering.

In some embodiments, the computing device may further generate an aggregated session (e.g., 470 of FIG. 4) using the one or more candidate combinations of sessions, and adjust a sequence of individual sessions within the aggregated session based on at least one of the one or more effectiveness metrics indicated in the profiles (e.g., 410, 420, or 430 of FIG. 4) or predicted by the ML model (e.g., 440 or 450 of FIG. 4), or one or more participant preferences (e.g., 320 of FIG. 3) indicated in the profiles.

In some embodiments, the plurality of educational sessions may comprise one or more recorded sessions and one or more live-streaming sessions.

In some embodiments, the computing device may further onboard the aggregated session to a platform in which one or more participants attend the aggregated session in a cross-collaboration manner.

In some embodiments, the aggregated session (e.g., 470 of FIG. 4) may comprise one or more recorded sessions and one or more live-streaming sessions. The computing device may further utilize generative models, comprising generative adversarial networks (GANs), to align participant digital representations from the recorded sessions with participant digital representations from the live-streaming sessions within the platform.

To generate the one or more mode tags for each session, the computing device may analyze textual data associated with each session by applying natural language processing (NLP) algorithms to identify one or more textual features indicating the mode of education delivery, or analyze visual content associated with each session by applying convolutional neural networks (CNNs) to identify one or more visual features indicating the mode of education delivery.

To generate the one or more mode tags for each session, the computing device may use a trained ML classification model to identify the mode of education delivery for each session based on at least one of the one or more textual features or the one or more visual features.

To generate the one or more content tags for each session, the computing device may analyze textual data associated with each session by applying natural language processing (NLP) algorithms to identify one or more textual features indicating the topic of instruction.

In some embodiments, the mode of education delivery may be selected from the group consisting of a theory class, a demo class, a real-life scenario class, or a use case class.

In some embodiments, the one or more effectiveness metrics may be selected from the group consisting of comprehension rate, knowledge retention degree, and participation level.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
accessing a data repository comprising a plurality of educational sessions;
generating one or more mode tags for each session to specify a mode of education delivery;
generating one or more content tags for each session to specify a topic of instruction;
creating one or more profiles to track participant actions, wherein each respective profile comprises one or more effectiveness metrics across a respective combination of sessions attended by a respective participant;
training a machine learning (ML) model to learn correlations between the combinations of sessions and the effectiveness metrics, as indicated in the one or more profiles;
predicting one or more effectiveness metrics for other combinations of sessions lacking profile data using the trained ML model;
clustering the combinations of sessions indicated in the profiles and the other combinations of sessions using the effectiveness metrics; and
selecting one or more candidate combinations of sessions for aggregation based on the clustering.

2. The computer-implemented method of claim 1, further comprising:
generating an aggregated session using the one or more candidate combinations of sessions; and
adjusting a sequence of individual sessions within the aggregated session based on at least one of the one or more effectiveness metrics indicated in the profiles or predicted by the ML model, or one or more participant preferences indicated in the profiles.

3. The computer-implemented method of claim 1, wherein the plurality of educational sessions comprises one or more recorded sessions and one or more live-streaming sessions.

4. The computer-implemented method of claim 2, further comprising onboarding the aggregated session to a platform in which one or more participants attend the aggregated session in a cross-collaboration manner.

5. The computer-implemented method of claim 4, wherein the aggregated session comprises one or more recorded sessions and one or more live-streaming sessions, the method further comprising:
utilizing generative models, comprising generative adversarial networks (GANs), to align participant digital representations from the recorded sessions with participant digital representations from the live-streaming sessions within the platform.

6. The computer-implemented method of claim 1, wherein generating the one or more mode tags for each session comprises:
analyzing textual data associated with each session by applying natural language processing (NLP) algorithms to identify one or more textual features indicating the mode of education delivery; or
analyzing visual content associated with each session by applying convolutional neural networks (CNNs) to identify one or more visual features indicating the mode of education delivery.

7. The computer-implemented method of claim 6, wherein generating the one or more mode tags for each session comprises:
using a trained ML classification model to identify the mode of education delivery for each session based on at least one of the one or more textual features or the one or more visual features.

8. The computer-implemented method of claim 1, wherein generating the one or more content tags for each session comprises:
analyzing textual data associated with each session by applying natural language processing (NLP) algorithms to identify one or more textual features indicating the topic of instruction.

9. The computer-implemented method of claim 1, wherein the mode of education delivery is selected from the group consisting of a theory class, a demo class, a real-life scenario class, a use case class.

10. The computer-implemented method of claim 1, wherein the one or more effectiveness metrics are selected from the group consisting of comprehension rate, knowledge retention degree, and participation level.

11. A system, comprising:
one or more memories collectively containing one or more programs; and
one or more processors, wherein the one or more processors are configured to, individually or collectively, perform an operation comprising:
accessing a data repository comprising a plurality of educational sessions;
generating one or more mode tags for each session to specify a mode of education delivery;
generating one or more content tags for each session to specify a topic of instruction;
creating one or more profiles to track participant actions, wherein each respective profile comprises one or more effectiveness metrics across a respective combination of sessions attended by a respective participant;
training a machine learning (ML) model to learn correlations between the combinations of sessions and the effectiveness metrics, as indicated in the one or more profiles;
predicting one or more effectiveness metrics for other combinations of sessions lacking profile data using the trained ML model;
clustering the combinations of sessions indicated in the profiles and the other combinations of sessions using the effectiveness metrics; and
selecting one or more candidate combinations of sessions for aggregation based on the clustering.

12. The system of claim 11, wherein the operation further comprises:
generating an aggregated session using the one or more candidate combinations of sessions; and
adjusting a sequence of individual sessions within the aggregated session based on at least one of the one or more effectiveness metrics indicated in the profiles or predicted by the ML model, or one or more participant preferences indicated in the profiles.

13. The system of claim 11, wherein the plurality of educational sessions comprise one or more recorded sessions and one or more live-streaming sessions.

14. The system of claim 11, wherein the operation further comprises onboarding the aggregated session to a platform in which one or more participants attend the aggregated session in a cross-collaboration manner.

15. The system of claim 14, wherein the aggregated session comprises one or more recorded sessions and one or more live-streaming sessions, and wherein the operation further comprises:
utilizing generative models, comprising generative adversarial networks (GANs), to align participant digital representations from the recorded sessions with participant digital representations from the live-streaming sessions within the platform.

16. The system of claim 14, wherein generating the one or more mode tags for each session comprises:
analyzing textual data associated with each session by applying natural language processing (NLP) algorithms to identify one or more textual features indicating the mode of education delivery; or
analyzing visual content associated with each session by applying convolutional neural networks (CNNs) to identify one or more visual features indicating the mode of education delivery.

17. The system of claim 16, wherein generating the one or more mode tags for each session comprises:
using a trained ML classification model to identify the mode of education delivery for each session based on at least one of the one or more textual features or the one or more visual features.

18. The system of claim 11, wherein generating the one or more content tags for each session comprises:
analyzing textual data associated with each session by applying natural language processing (NLP) algorithms to identify one or more textual features indicating the topic of instruction.

19. One or more computer-readable media containing, in any combination, computer program code that, when executed by a computer system, performs an operation comprising:
accessing a data repository comprising a plurality of educational sessions;
generating one or more mode tags for each session to specify a mode of education delivery;
generating one or more content tags for each session to specify a topic of instruction;
creating one or more profiles to track participant actions, wherein each respective profile comprises one or more effectiveness metrics across a respective combination of sessions attended by a respective participant;
training a machine learning (ML) model to learn correlations between the combinations of sessions and the effectiveness metrics, as indicated in the one or more profiles;
predicting one or more effectiveness metrics for other combinations of sessions lacking profile data using the trained ML model;
clustering the combinations of sessions indicated in the profiles and the other combinations of sessions using the effectiveness metrics; and
selecting one or more candidate combinations of sessions for aggregation based on the clustering.

20. The one or more computer-readable media of claim 19, wherein the operation further comprises:
generating an aggregated session using the one or more candidate combinations of sessions; and
adjusting a sequence of individual sessions within the aggregated session based on at least one of the one or more effectiveness metrics indicated in the profiles or predicted by the ML model, or one or more participant preferences indicated in the profiles.
